(19) United States
(12) Patent Application Publication
(10) Pub. No.: US 2016/0152111 A1
(43) Pub. Date: Jun. 2, 2016

(54) Heating Device For A Seat Heater Of A Motor Vehicle

(71) Applicant: KONGSBERG AUTOMOTIVE AB, Mullsjo (SE)

(72) Inventor: Milan Tüskes, Munchen (DE)

(73) Assignee: KONGSBERG AUTOMOTIVE AB, Mullsjo (SE)

(21) Appl. No.: 14/947,587

(22) Filed: Nov. 20, 2015

(30) Foreign Application Priority Data
Nov. 21, 2014 (DE) 202014105623.8

(51) Int. Cl. B60H 1/00; H05B 3/36

(52) U.S. Cl. CPC B60H 1/00285; H05B 3/36

(57) ABSTRACT

The present invention is directed to a heating device for a seat heater of a motor vehicle, which heating device is adapted to be placeable between a base body (2) of foam and a seat cover (8) of a vehicle seat, and which heating device comprises a heating mat (6) having a carrier layer which carries a heating conductor extending over a heating area, and a foam layer as a seat cover upholstery (4), which seat cover upholstery (4) is connected to the heating mat (6) surface which carries the heating conductor, characterized in that the heating device is adapted to be, with the heating mat (6) in direct contact with the seat cover (8), sewable by stitches going through the seat cover (8), the heating mat (6) and the seat cover upholstery (4) to form seams (12) extending through the heating area, by forming the heating conductor as a stranded conductor comprising at least 100 metal filaments.

The present invention is directed to a heating device for a seat heater of a motor vehicle, which heating device is adapted to be placeable between a base body of foam and a seat cover of a vehicle seat, and which heating device comprises a heating mat having a carrier layer which carries a heating conductor extending over a heating area, and a foam layer as a seat cover upholstery, which seat cover upholstery is connected to the heating mat surface that carries the heating conductor.

Motor vehicle seats comprise a seat body and a backrest connected thereto. Each of these includes a base body of foam including a carrier frame and a base body of cushioning material surrounding the carrier frame. On the outside the base body of foam is surrounded by a seat cover made of textile or leather. In the seating area (which in connection with the present application also includes a surface portion of the backrest which is in contact with the back of a person sitting on the motor vehicle seat) a heating device is disposed between the base body of foam and the seat cover in each of the seat body and the backrest. Such heating device is a compound including a heating mat, which heating mat carries a heating conductor running back and forth thereon, for example a heating conductor extending in a meander pattern, or several parallel heating conductors, and a seat cover upholstery which according to the prior art is located directly underneath the seat cover and which is intended to improve the seating comfort.

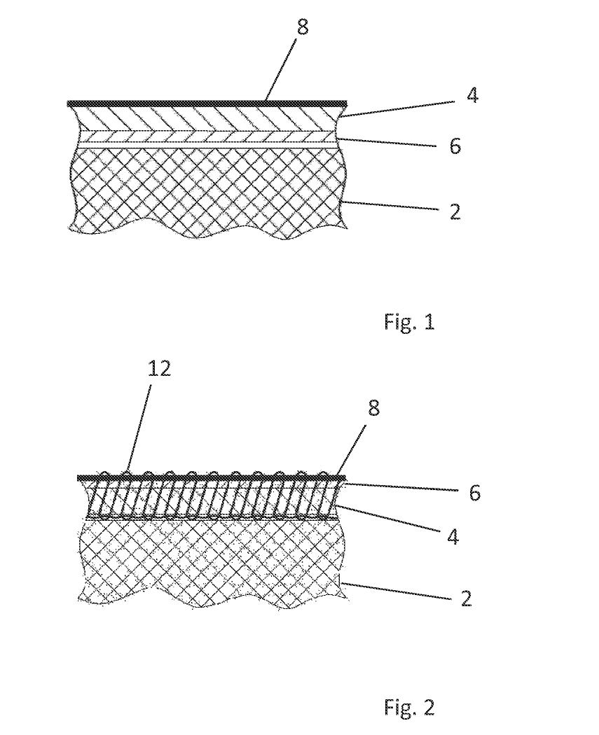

A portion of a vehicle seat according to the prior art is shown in FIG. 1 in cross-section. On the foam base body 2 the heating device is located in the seating area, which heating device comprises a heating mat 6 and a foam layer as a seat cover upholstery 4. On the side of the heating mat 6 facing the seat over upholstery 4 a heating conductor is laid which is connected to the heating mat 6. The heating conductor may extend running forth and back or may comprise a plurality of parallel individual conductors in order to achieve a coverage of the seating area as uniform as possible, to thereby achieve heating power distributed as uniformly as possible over the seating area.

The seat cover upholstery 4 consists of a soft foam material and is intended to improve seating comfort. This seat cover upholstery is located directly underneath the outer material of the seat cover 8 made of textile or leather, in order to influence the seat feeling directly at the outer material of the seat cover. It is a disadvantage of this design that the heat generated by the heating conductor first has to pass the seat cover upholstery 4 in order to be conducted to the seat cover 8. Since heat transfer through a foam layer by heat conduction and convection has a low level of efficiency, the level of efficiency of the heating device is poor.

It is an object of the present invention to arrange a heating device for a motor vehicle seat heating in such a manner that at a given level of heating power generated by the heating conductor an increased effective heating power available at the seat cover surface is achieved.

This object is achieved by a heating device comprising the features of claim 1. Preferred embodiments are set out in the dependent claims.

According to the present invention the heating device is adapted to be, with the heating mat in direct contact with the seat cover, to be sewable to the seat cover by stitches going though the seat cover, the heating mat and the seat cover upholstery to form seams extending over the heating area, by forming the heating conductor as a stranded conductor comprising at least 100 metal filaments. Due to the location of the heating mat directly underneath the seat cover and due to the sewing up forming seams extending over the heating area, a particular intimate contact of heating mat and seat cover is achieved, in particular in the seating area, which results in a substantially improved heat conduction from the heating conductor to the seat cover. It turned out that sewing up with seams running along the seating area of the heating mat (and thus crossing the heating conductor) is possible without damages of the heating conductor that could affect its performance, if the heating conductor is formed as a stranded conductor comprising at least 100 metal filaments. Even if, when forming the seams in the heating area, the heating conductor is directly struck by a needle forming the seam, the vast majority of the individual filaments of the heating conductor are displaced in lateral direction by the piercing needle, and only few individual metal filaments are damaged or severed. On the other hand the vast majority of the metallic filaments of the stranded conductor remain undamaged such that the performance of the heating conductor is not affected. This also permits that the seating area can be structured by a pattern of a plurality of seams lying close together, to thereby achieve a uniform, intimate contact of heating mat and seat cover by a fine mesh of seams extending over the seating area.

By arranging the heating conductor as a stranded conductor with more as 100 metal filaments it is also made possible that the heating device according to the invention can be sewn up in the heating area by stitches lying closely together to form tight seams, to thereby form a close and intimate contact between seat cover and heating mat.

In a preferred embodiment the heating conductor is formed as a stranded conductor with more than 300 metal filaments. In a particularly preferred embodiment the heating conduct has a stranded conductor with more than 500 metal filaments.

In a preferred embodiment the carrier layer of the heating mat is arranged to be air permeable to allow venting of the seat surface by a ventilator located in the motor vehicle seat. In order to ensure air permeability the carrier layer may consists of reticulated foam or may be provided with perforations.

The invention is also directed to a motor vehicle seat comprising a base body of foam, an outer seat cover and a heating device according to any of claims 1 to 4 which heating device is located between the seat cover and the base body of foam, wherein the heating mat of the heating device is in direct contact with the seat cover and the seating area is provided with a plurality of seams running along the heating area, wherein stitches of the seams extend through the seat cover and the seating device, such the seating area is structured by a pattern of seams and such that an intimate contact between heating mat and seat cover is formed.

The invention will now be described with reference to an embodiment in connection with the drawings in which:

FIG. 1 is a partial view of a motor vehicle seat in cross-section including a heating device according to the prior art;

FIG. 2 is a partial view of a motor vehicle seat in cross-section, including a heating device according to an embodiment of the invention; and

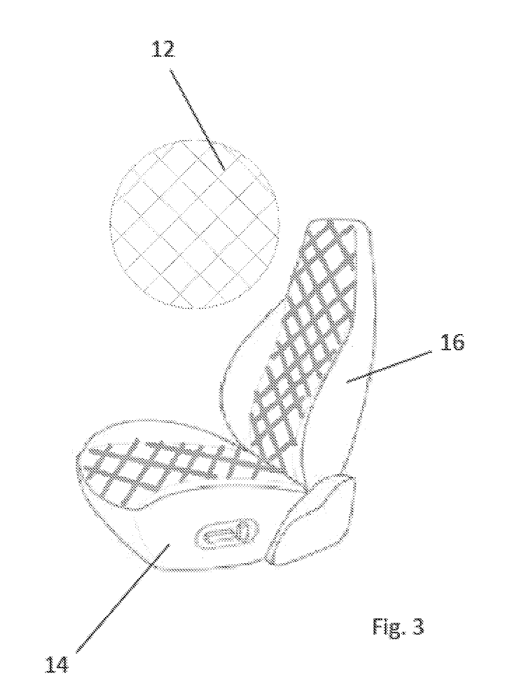

FIG. 3 is a perspective view of a motor vehicle seat and an enlarged detail of the seating area in a plan view.

FIG. 2 shows a partial view of a motor vehicle seat in cross-section in the heating area of the heating device. Between the base body 2 of foam and the seat cover 8 a heating device is disposed, which heating device is formed as a compound of a seat cover upholstery 4 made of foam and a heating mat 6. The heating mat 6 carries on its surface facing the seat cover upholstery 4 the heating conductor which is connected to the carrier layer by gluing or stitching. The carrier layer of the heating mat may consist of felt, fleece, woven material or cut foam.

As shown in FIG. 2 the stitches of the seam 12 are applied such that they pierce through the seat cover 8, the heating mat 6 and the seat cover upholstery 4.

The heating conductor, which is not shown in the drawings, is formed as a stranded conductor comprising a plurality of individual filaments, for example stainless steel filaments. The heating conductor may also consist of several stranded conductors which themselves are stranded with each other. In any case the heating conductor has at least 100 individual metal filaments. The diameter of the individual filaments is within the range from 100 nm to 100 μm. With the heating conductor formed in this manner by a plurality of individual elements it is possible to apply seams 12 to the heating area, with seams crossing the extension of the heating conductor, without causing damages to the heating conductor by the sewing process which could affect the performance of the heating conductor. It turned out that, if a needle hits a heating conductor directly, the vast majority of the individual filaments of the heating conductor is displaced or pushed aside, and that damages can only occur for a few individual filaments. If a few individual filaments are damaged the performance of the heating conductor as whole is not reduced.

For this reason it is possible for a motor vehicle seat in which between base body of foam and seat cover a heating device according to the present invention is placed, to provide the heating area with a dense pattern of seams, as is for example illustrated in FIG. 3. The seating body of the motor vehicle seat, namely on the actual seat body 14 and on the backrest 16, is provided with the plurality of parallel first seams and, at an angle with respect to the first seams, with a second plurality of parallel seams which together form a diamond pattern.

In this manner a close and intimate contact of seat cover and heating mat may be achieved in the entire heating area. It was found that by the seams in the heating area the heating power at the surface of the seat cover is almost doubled compared to the situation in which seams are extending only outside of the heating area.

By the combination of the measures that the heating mat of the heating device according to the invention is in direct contact with the seat cover, and that the heating device is arranged such that it can be provided with seams in the heating area, which seas connect heating device and seat cover, a substantially improved efficiency of the heating device is achieved, i.e. at a given heat energy generated by the heating conductor a substantially increased effective heating power at the seat cover surface is achieved.

1. Heating device for a seat heater of a motor vehicle, said heating device adapted to be placeable between a base body (2) of foam and a seat cover (8) of a vehicle seat, and said heating device comprising:
a heating mat (6) having a carrier layer which carries a heating conductor extending over a heating area with said heating conductor being a stranded conductor comprising at least 100 metal filaments, and
a seat cover upholstery (4) comprising a foam layer with said seat cover upholstery (4) connected to a surface of said heating mat (6) that carries said heating conductor,
wherein said heating mat (6) is adapted to be in direct contact with the seat cover (8) and sewable by stitches going through the seat cover (8), said heating mat (6) and the seat cover upholstery (4) to form seams (12) extending through said heating area.

2. Heating device according to claim 1, wherein said heating conductor is a stranded conductor comprising at least 300 metal filaments.

3. Heating device according to claim 1, wherein said heating conductor is a stranded conductor comprising at least 500 metal filaments.

4. Heating device according to claim 1, wherein said carrier layer of said heating mat (6) consists of felt, fleece, woven material or cut foam.

5. Heating device according to claim 1, wherein said carrier layer of said heating mat (6) is arranged to be air permeable.

6. Heating device according to claim 5, wherein said carrier layer of said heating mat (6) is formed of reticulated foam or is provided with perforations in order to ensure air permeability.

7. (canceled)

8. Heating device according to claim 1, wherein said heating conductor is a stranded conductor comprising at least 200 metal filaments.

9. Heating device according to claim 1, wherein each of said metal filaments has a diameter of from 100 nm to 100 μm.

10. Motor vehicle seat comprising:
a base body of foam (2);
a seat cover (8); and
a heating device disposed between said base body of foam (2) and said seat cover (8), said heating device comprising;
a heating mat (6) having a carrier layer which carries a heating conductor extending over a heating area with said heating conductor being a stranded conductor comprising at least 100 metal filaments, and
a seat cover upholstery (4) comprising a foam layer with said seat cover upholstery (4) connected to a surface of said heating mat (6) that carries said heating conductor;
wherein said heating mat (6) is in direct contact with the seat cover (8) and sewn by stitches going through said seat cover (8), said heating mat (6), and said seat cover upholstery (4) to form seams (12) extending through said heating area.

11. Motor vehicle seat according to claim 10, wherein said heating conductor is a stranded conductor comprising at least 200 metal filaments.

12. Motor vehicle seat according to claim 10, wherein each of said metal filaments has a diameter of from 100 nm to 100 μm.

13. Motor vehicle seat according to claim 10, comprising a plurality of parallel first seams and, at an angle with respect to the first seams, a second plurality of parallel seams which together form a diamond pattern on said seat cover.
